(19) United States
(12) Patent Application Publication
(10) Pub. No.: US 2005/0150916 A1
(43) Pub. Date: Jul. 14, 2005

(54) Dispenser device having a pivotable nozzle

(75) Inventor: Vincent De Laforcade, Rambouillet (FR)

Correspondence Address: OLIFF & BERRIDGE, PLC, P.O. BOX 19928, ALEXANDRIA, VA, 22320, US

(73) Assignee: L'OREAL, Paris (FR)

(21) Appl. No.: 11/012,487

(22) Filed: Dec. 16, 2004

Related U.S. Application Data
(60) Provisional application No. 60/538,217, filed on Jan. 23, 2004.

(30) Foreign Application Priority Data
Dec. 18, 2003 (FR) 03 51119

(51) Int. Cl. B67D 5/06

(52) U.S. Cl. 222/534

(57) ABSTRACT

A dispenser device may include: a support having a feed orifice that can be supplied with fluid; and, a nozzle that has an orifice for passing the fluid, the nozzle being mounted so as to pivot on the support between at least: a closed position at which the nozzle closes the feed orifice of the support; a first dispensing position at which the feed orifice of the support communicates with an orifice of the nozzle; and, a second dispensing position, one of the feed orifice of the support and the orifice of the nozzle being provided with a flexible sealing lip that has an edge that is not entirely contained in a single plane and that is arranged to seal communication between the feed orifice of the support and the orifice of the nozzle at least in the first and second dispensing positions.

### CROSS-REFERENCE TO RELATED APPLICATIONS

This non-provisional application claims the benefit of French Application No. 03 51119 filed on Dec. 18, 2003 and U.S. Provisional Application No. 60/538,217 filed on Jan. 23, 2004, the entire disclosures of which are incorporated herein.

### BACKGROUND

The present invention relates to dispenser devices of the kind having a support and a dispenser nozzle that is pivotally movable relative to the support between at least a closed position and a dispensing position, in which the orifice in the support coincides with the orifice in the nozzle.

In particular, the invention applies to dispenser devices that dispense fluids, especially liquids, for example, a cosmetic, including a skin care product, or a substance used for medical treatment, e.g., dermatological treatment.

A difficulty faced by those dispenser devices is to obtain sufficient dynamic sealing between the nozzle and the support to ensure that the dispenser device does not leak, because, unlike a static seal, the seal between the nozzle and the support must be compatible with the nozzle moving relative to the support.

Moreover, account must be taken of the fact that it must be possible to manufacture the parts at a low cost price, so manufacturing tolerances might be relatively slack. For example, differences in dimensions arise from the material shrinking on cooling, from variations due to humidity, etc.

In known dispenser devices, in order to achieve leaktightness, the nozzle is pressed tightly against the support so that adequate sealing is obtained, despite manufacturing tolerances.

In order to ensure that it is not too difficult to move the nozzle, while simultaneously ensuring that the contact pressure is sufficiently high, the nozzle and the support make contact via a narrow bead that is about 1 millimeter (mm) wide, said bead going around one of the orifices of the support and one of the orifices of the nozzle, with its edge being contained entirely in a single plane.

The angle between the position in which orifices of the support and the nozzle coincide perfectly and the position in which they do not coincide at all, is the angle that is subtended by the arc inscribed in the diameter of the larger orifice. The smaller said arc is, the less will be the effect on sealing quality of a small variation in the radius of curvature of either of the two parts, due to the manufacturing tolerances.

Thus, the devices that are found on the market are of the “open/closed” type, which means that they offer a closed position where the two orifices do not coincide, and a single open position, where, after pivoting through 90°, the two orifices do coincide, releasing a passage for the fluid.

Those known dispenser devices do not offer the possibility of varying the angle of inclination of the nozzle relative to the support to a considerable extent while simultaneously allowing the fluid to be dispensed, because the angle at which the two orifices coincide must be relatively small if it is desired to maintain sealing, for the reasons explained above.

Therefore, there exists a need for having the advantage of a dispenser device that has a nozzle which can pass from a closed position to at least two different dispensing positions, transition from the first dispensing position to the second dispensing position taking place through additional pivoting of the nozzle, for example through at least 30°, without thereby excessively increasing the cost price of the dispenser device, and while retaining the required leaktightness.

Moreover, dispenser devices are known through Patent Nos. GB-1,122,474, U.S. Pat. No. 4,773,801, U.S. Pat. No. 2,717,726, U.S. Pat. No. 3,863,818, U.S. Pat. No. 6,390,341 and JP-4-294751, and U.S. patent application Publication No. 2003/0111493, each of said dispenser devices having a pivotable nozzle and a support, said support comprising a sealing lip with an edge that can be pressed against the nozzle. These devices are designed to have only a single dispensing position.

U.S. Pat. No. 2,197,672 describes a dispenser device that includes a pivotable nozzle that can assume two dispensing positions and an intermediate closed position. The nozzle includes a sealing element in cork or in some other elastically deformable material that is placed in such a manner as to block the orifice of the support through which the fluid reaches the nozzle. A sealing link in rubber or cork is pressed against the nozzle by a ring screwed onto the support.

U.S. Pat. No. 4,767,027 describes a measuring vessel that is able to pivot relative to a support designed to be screwed onto a receptacle, for example, a receptacle containing oil, in order to mix the oil with gasoline in a predefined ratio.

### SUMMARY

Exemplary embodiments of the invention provide a dispenser device comprising: a support having a feed orifice that can be supplied with fluid; and a nozzle that has an orifice for passing the fluid. The nozzle may be mounted so as to pivot on the support between at least: a closed position at which the nozzle closes the feed orifice of the support; a first dispensing position at which the feed orifice of the support communicates with an orifice of the nozzle, transition from the closed position to the first dispensing position being effected through rotation by the nozzle relative to the support; and, a second dispensing position, transition from the first dispensing position to the second dispensing position being effected by further turning of the nozzle relative to the support. At least one of the feed orifice of the support and the orifice of the nozzle may be provided with a flexible sealing lip that has, for example, at least when the sealing lip is not substantially submitted to any strain, an edge that is not entirely contained in a single plane and that is arranged to seal communication between the feed orifice of the support and the orifice of the nozzle at least in the first and second dispensing positions.

The edge of the sealing lip may, for example, extend about a pivot axis of the nozzle relative to the support over an angle of at least 45°. For example, edge of the sealing lip may extend over an angle of at least 60°, and, for example, about 90°.

Since the edge of the sealing lip may have a relatively wide angular movement around the pivot axis of the nozzle, at least two dispensing positions are allowed that correspond to totally different orientations of the nozzle, for example, the first position being after the nozzle is pivoted about 45° relative to the closed position and the second position after said nozzle is pivoted for a further 45°.

According to various embodiments, the user may benefit from at least two dispensing positions in which the nozzle has a different orientation relative to the support without there being any concern about leakage due to manufacturing tolerances as a result of eliminating manufacturing clearance through the sealing lip. Said sealing lip may allow for dynamic sealing without the necessity of securing the nozzle so tightly that its rotation is obstructed unnecessarily.

For example, a plurality of dispensing positions makes it possible to dispense the fluid when the longitudinal axis of the nozzle is at substantially 45° with the axis of the receptacle onto which the support is mounted, so that, for example, a hair product may be spread over the back of the head. Then, the nozzle may be pivoted so that its longitudinal axis is substantially parallel to the longitudinal axis of the receptacle, so that, for example, the fluid may be spread all over the head of hair.

The pivot axis may be substantially perpendicular to the longitudinal axis of the receptacle. Advantageously, the sealing lip may be made of a same material as the support, preferably made integrally, i.e., monolithically with said support, which enables manufacture at a low price. The lip may be molded thin enough to conform locally to any variation in the manufacturing gradients of the nozzle, in order to accommodate manufacturing clearance.

The sealing lip may taper toward its edge, which may increase its deformability. For example, the lip may have a triangular cross-section. The lip may be on an incline relative to an axis of the support and, for example, may slope toward an inside of the feed orifice of the support.

The edge of the sealing lip may extend substantially over a circularly cylindrical surface. For example, said cylindrical surface may have a generator that is parallel to the pivot axis of the nozzle.

The sealing lip may be supported by a bead, for example, that extends parallel to an axis of the support. For example, the bead may extend parallel to an axis that corresponds to an unmolding direction of the support.

For example, the support may include an assembly skirt that enables the support to be secured to a receptacle. For example, the assembly skirt may enable the support to be secured to a neck of the receptacle. The skirt may have, for example, an inside thread. The axis of the support may correspond to the axis of said assembly skirt.

The support may also have a sealing lip that is configured to be pressed in a leaktight manner against an inside surface of the receptacle, for example, the inside surface of the neck.

The support may also have an outside covering skirt that is connected at a top thereof to the assembly skirt.

The orifice of the nozzle may open out in a cylindrical surface of the nozzle. The cylindrical surfacing may have a generator line that is substantially parallel to the pivot axis. The nozzle may be a single piece.

The support may include a notch for receiving a pipe of the nozzle when said nozzle is in the closed position. Said notch may be configured to allow the pipe to be snap-fastened thereto, which may make it easier for the nozzle to remain in a closed position, for example, when being carried.

The support may include housings for receiving two opposite studs of the nozzle so as to hinge the nozzle to the support. Said housings may be made to allow said studs to be snap-fastened thereto.

The support may also have at least a first portion in relief that is arranged to cooperate with a second portion in relief that corresponds to the nozzle. The cooperation of the first and second reliefs may generate at least one hard point in the turning of the nozzle at a predetermined orientation of the nozzle relative to the support.

The first portion in relief may comprise, for example, a tab made integrally, i.e., monolithically with the support. The tab may include a tooth arranged to be pressed against the nozzle in order to curb pivoting by said nozzle. The second portion in relief may comprise, for example, a recess made in the nozzle, for example, at the base of the pipe thereof. The tooth may become engaged in said recess when the nozzle is in a maximally pivoted position.

In various exemplary embodiments, the fluid may be dispensed without leaking in each dispensing position.

Preferably, the feed orifice of the support and the orifice of the nozzle extend about a pivot axis of the nozzle relative to the support, respectively over a first angle and a second angle. The second angle may be different from the first angle, with, for example, the angle associated with the orifice provided with the sealing lip being larger than the angle associated with the other orifice, e.g., being twice as large.

In exemplary embodiments, the entire section of one of the feed orifice of the support and the orifice of the nozzle opens out into the other one of the feed orifice of the support and the orifice of the nozzle when the nozzle is in each of the dispensing positions.

One of the feed orifice of the support and the orifice of the nozzle may open out advantageously into the other one of the feed orifice of the support and the orifice of the nozzle (provided with the sealing lip) inside the outline of said lip, at least when the nozzle is in one of the dispensing positions, preferably in each dispensing position.

In exemplary embodiments, at least one of the support and the nozzle may have an annular bead with an edge that is not contained entirely in a single plane. The sealing lip may be connected to said edge of the annular bead.

Exemplary embodiments of the invention provide a method for applying a fluid product to hair. The method may comprise: using a dispenser device, such as defined above, to apply fluid to a back of a head while a pipe of the nozzle is orientated at substantially 45° relative to the longitudinal axis of the receptacle; using the dispenser device to apply the fluid to the head while the pipe or dispensing tube of the nozzle is substantially parallel to the longitudinal axis of the receptacle.

Exemplary embodiments of the invention provide a dispenser device that comprises: a support having a feed orifice that can be supplied with a fluid; and, a nozzle that has an orifice enabling the passage of fluid. The nozzle may be mounted so as to pivot on a support around a pivot axis between at least: a closed position at which the nozzle closes the feed orifice of the support; a first dispensing position at which the feed orifice of the support communicates with the orifice of the nozzle, transition from the closed position to the first dispensing position being effected through rotation by the nozzle relative to the support; and, a second dispensing position, transition from the first dispensing position to the second dispensing position being effected through further rotation by the nozzle relative to the support, the feed orifice of the support being provided with a sealing lip that is deformable. The sealing lip may be flexible, and may be made of a same material as the support.

Exemplary embodiments of the invention provide a packaging and dispenser device that comprises: a receptacle that contains a product to be dispensed; a support that has a feed orifice that can be supplied with fluid contained in the container; and, a nozzle that has an orifice enabling the passage of fluid. The nozzle may be mounted so as to pivot on the support around a pivot axis between at least: a closed position in which the nozzle closes the feed orifice of the support; a first dispensing position at which the feed orifice of the support communicates with the orifice of the nozzle, transition from the closed position to the first dispensing position being effected through rotation by the nozzle by about 45° relative to the support; and, a second dispensing position, transition from the first dispensing position to the second dispensing position being effected through further rotation by about 45° by the nozzle relative to the support.

### BRIEF DESCRIPTION OF THE DRAWINGS

The invention will be better understood on reading the following detailed description of a non-limiting embodiment of the invention, and on examining the accompanying drawings, in which:

FIG. 1 is a diagrammatic perspective view of an exemplary dispenser device, the nozzle being in a closed position;

FIG. 2 is a view identical to FIG. 1, the nozzle being shown in a maximally pivoted position;

FIG. 3 is a view identical to FIG. 1, the device of FIGS. 1 and 2 shown after the nozzle has been pivoted, being in an intermediate position between the closed position and the maximally pivoted position;

FIG. 4 is a diagrammatic top perspective view of the support and the nozzle, said nozzle being removed from the support;

FIG. 5 is a longitudinal, fragmentary and diagrammatic section taken on a mid-plane of FIG. 4;

FIG. 6 shows the sealing lip on a larger scale; and

FIGS. 8 to 10 are longitudinal sections that correspond to positions of the nozzle and the support as shown in FIGS. 1, 2, and 3, respectively.

### DETAILED DESCRIPTION OF EMBODIMENTS

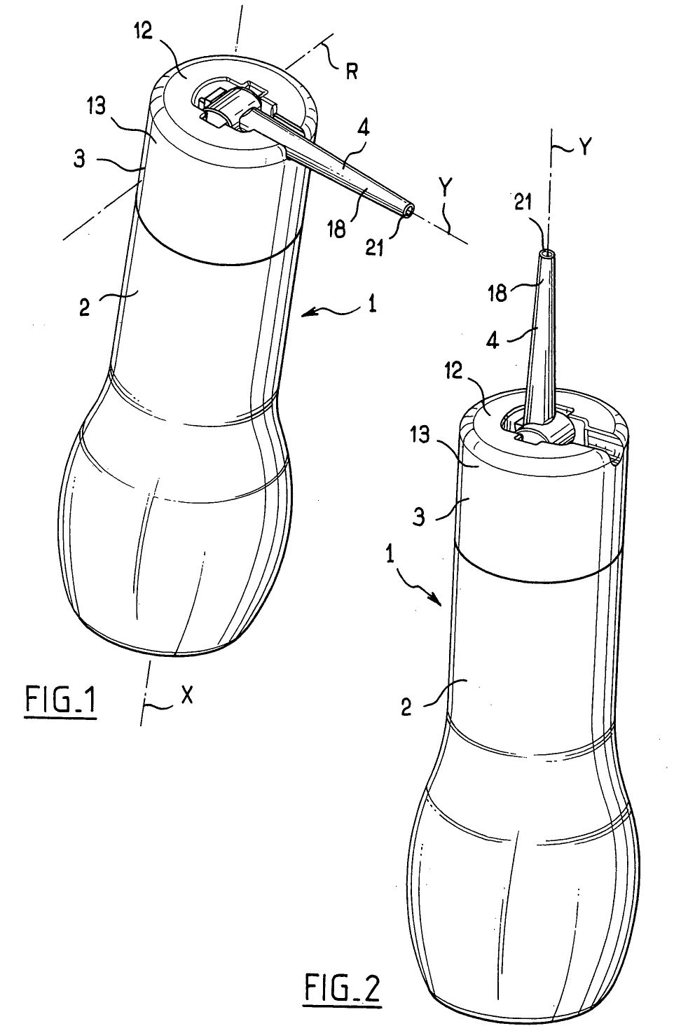

FIGS. 1 to 3 show an exemplary packaging and dispenser device 1 that comprises a receptacle 2 of elongate shape, and a dispenser nozzle 4 that can turn relative to a support 3 about a pivot axis 4 that is perpendicular to the longitudinal axis X of the dispenser device 1.

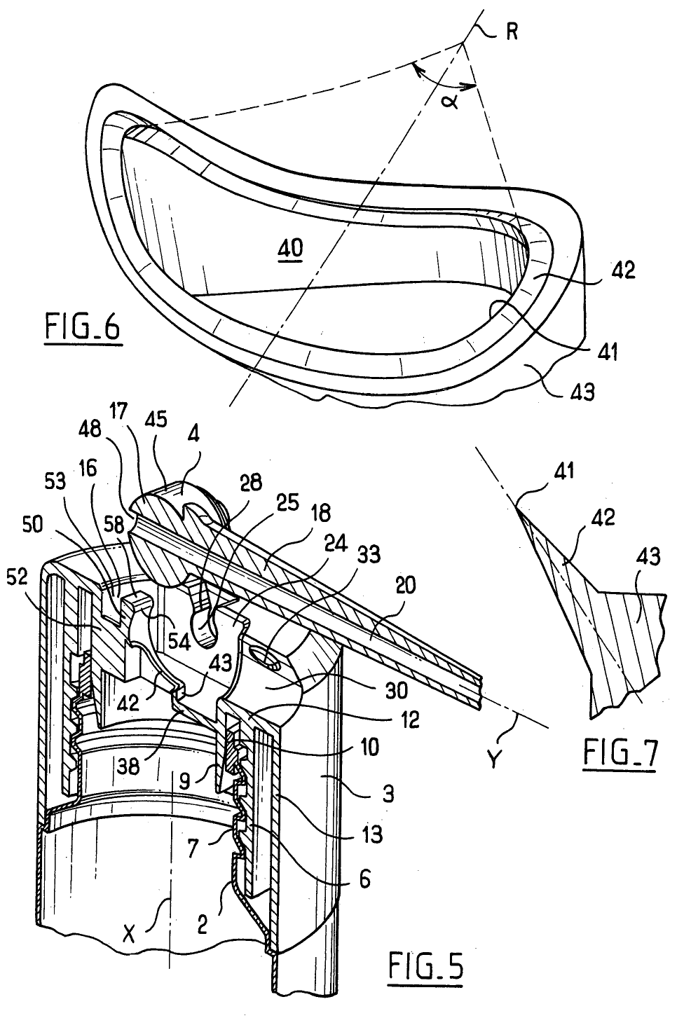

As shown in FIG. 5, the support 3 may comprise an assembly skirt 6, that is tubular about an axis X, that is internally threaded, and that is screwed onto a threaded neck 7 of the receptacle 2.

Sealing may be obtained between the support 3 and the neck 7 of the receptacle by an annular sealing lip 9, for example. The sealing lip 9 may be pressed against a radially inner surface 10 of the neck 7.

The assembly skirt 6 and the annular lip 9 may be connected to a top wall 12 of the support 3. The top wall 12 may be extended downward at a periphery thereof by a covering skirt 13, which may extend substantially down to the base of the neck 7.

A housing 16 may be formed in the support 3 in order to receive a base portion 17 of the nozzle 4. The base portion 17 may have a dispenser nozzle 18 of longitudinal axis Y, that defines a channel 20 via which fluid contained in the receptacle 2 can be brought to an outlet orifice 21.

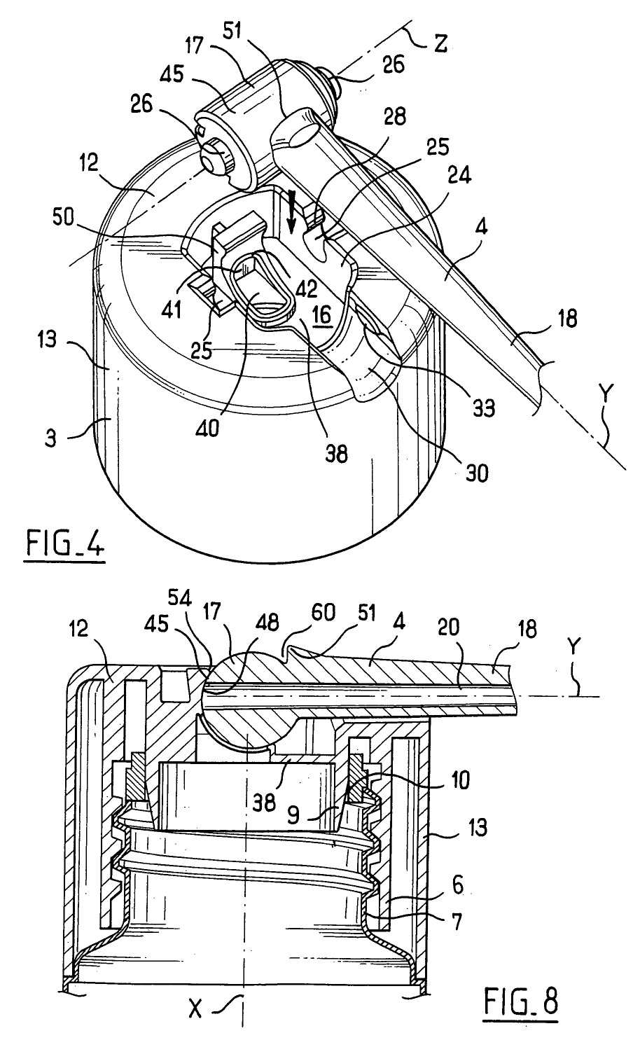

As shown in FIG. 4, the housing 16 may be defined laterally, for example, by two side walls 24 each having a respective housing 25 for receiving a respective cylindrical stud 26 on the base portion 17 in order to allow the nozzle 4 to pivot relative to the support 3 around the pivot axis R. Said pivot axis R may coincide with the axis W of the studs 26.

Each housing 25 may have a tapering top opening 28, which enables the studs 26 to snap into said housings 25 when the nozzle 4 is brought down onto the support in the direction of the arrow M in FIG. 4 for assembly purposes. As shown in FIG. 4, the support 3 may include a notch 30 in a top face thereof for receiving the dispenser nozzle 4 when the axis Y of said dispenser nozzle is substantially perpendicular to the longitudinal axis X. The notch 30 may be defined by an indentation of the top wall 12 and may have two studs 33 on flanks thereof that help to hold the nozzle 4 in the notch 30. The notch 30 may provide a hard point when the dispenser nozzle 4 pivots about the pivot axis R in order to be brought to a dispensing position.

The bottom of the housing 16 may be defined by a wall 38 which generally extends perpendicularly to the axis X and which connects, at a periphery thereof, to the annular lip 9.

A feed orifice 40 for feeding the nozzle 4 with fluid may open out into the housing 16. As shown, said feed orifice 40 is not an orifice of circular section contained in a plane, but is defined by the free edge 41 of a sealing lip 42, said edge 41 corresponding to the tip of the lip 42. At a base thereof, said lip 42 may be connected to a bead 43 which extends parallel to the axis X. The bead 43 may be supported by the wall 38, as shown in FIG. 5.

The edge 41 is not entirely in a single plane and the feed orifice 40 may extend about the axis R in an angle α of about 90°, for example, as shown in FIG. 6.

As shown in FIGS. 6 and 7, the lip 42 may be directed toward an inside of the feed orifice 40 and toward an outside of the housing 16, so that said lip 42 may be pressed, with elastic deformation, against a circularly cylindrical surface 45 about the axis Z at the base portion 17 of the nozzle 4, so as to ensure that contact between the support 3 and said surface 45 is leaktight. The lip 42 may also make it possible to accommodate manufacturing clearance, and, for example, to compensate for any variation in the radius of curvature of the surface 45.

When observed in cross-section as shown in FIG. 7, the lip 42 may extend along an axis W that makes an angle of about 45° with the axis X.

Said cross-section may be triangular as shown, and the base of said lip 42 may connect to an inside 43a of the bead 43 at a base thereof.

The channel 20 of the nozzle 4 may open out in the surface 45 via an orifice 48.

As shown in FIG. 4, for example, the support 3 may also include a tab 50 that is elastically deformable, said tab extending along the axis X. The feed orifice 40 may be situated between said tab 50 and the notch 30.

A reinforcing web 52 may extend parallel to the axis X and parallel to the axis of the notch 30 between the tab 50 and a wall 53 which extends the annular lip 9 upward, said wall 53 delimiting the housing 16 on the other side of the notch 30.

The tab 50 may be provided with a tooth 54 which presses against the surface 45 of the nozzle 4 when said nozzle is in the closed position, as shown in FIG. 8.

The base portion 17 of the nozzle may include a recess 60 at the bottom of the pipe 18, said recess 60 being formed at the junction of a protuberance 51 on the pipe 18 and the surface 45.

The tooth 54 may be engaged in the recess 60 when the longitudinal axis Y of the nozzle 4 is substantially parallel to the longitudinal axis X, as shown in FIG. 10. In this position, the protuberance 51 may come substantially against the top 58 of the tab 50.

When the longitudinal axis Y of the nozzle 4 is oriented substantially perpendicular to the longitudinal axis X of the receptacle 2, as shown in FIGS. 1 and 8, the orifice 48 may open out outside an outline of the lip 42, above the orifice 40, so that the channel 20 is not fed with fluid, and the receptacle is substantially closed, for example, in a hermetically sealed manner by the surface 45.

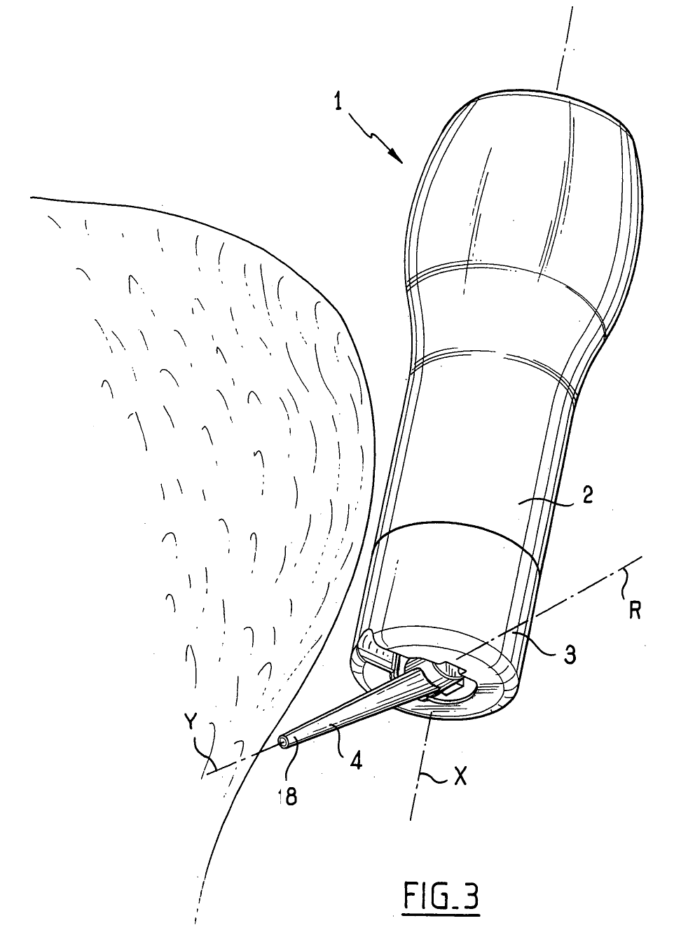

When the nozzle 4 pivots through 45° from the closed position, in the direction of the arrow O in FIG. 8, the orifice 48 may open out facing the feed orifice 40 within the outline of the lip 42, and fluid can reach the channel 20 of the nozzle 4, as shown in FIGS. 3 and 10.

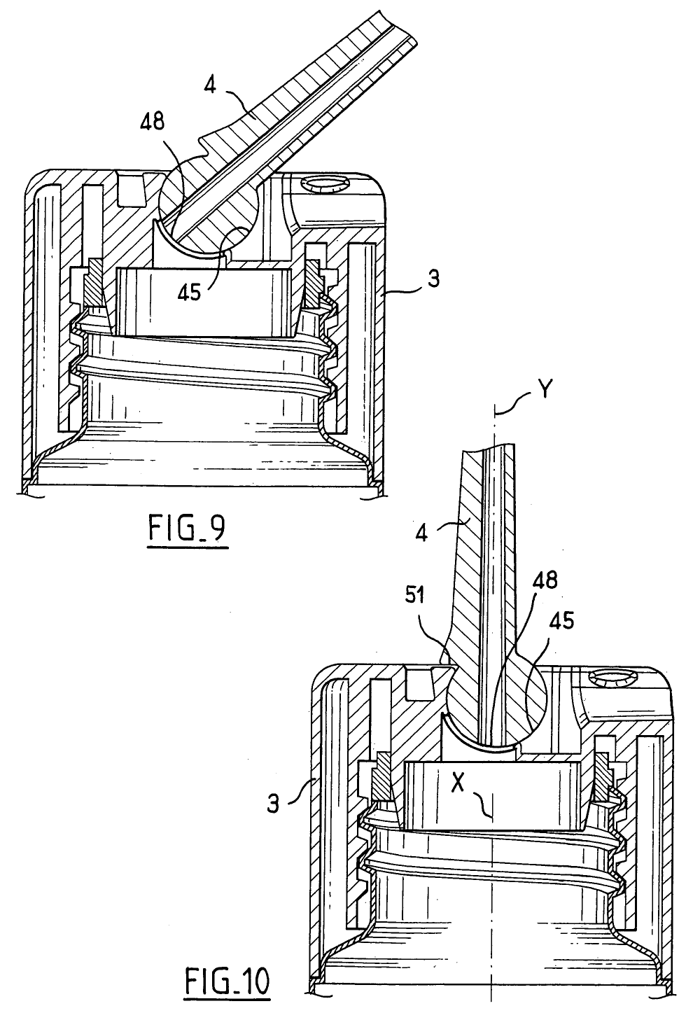

Lastly, when the nozzle 4 is brought to a maximally pivoted position thereof, as shown in FIGS. 2 and 9, the orifice 48 may always open out facing the feed orifice 40 inside the outline of the lip 42.

For example, the maximally pivoted position shown in FIG. 9 may be used to apply fluid to a head of hair, whereas the position shown in FIG. 10 may be used to dispense fluid on the nape of the neck.

Of course, the invention is not limited to the embodiment described above.

For example, the feed orifice 40 and the lip 42 may be given other shapes, if, for example, it is desired to alter the zone where the feed orifice 40 and the orifice 48 coincide and to dispense fluid from the nozzle, while said nozzle is in an angular position relative to the support that is different from the positions shown in FIGS. 9 and 10.

It is also possible to alter the dispenser nozzle 4 and, for example, to provide said nozzle with a plurality of outlet orifices through which the fluid is dispensed, said orifices opening out, if necessary, between the teeth of a comb.

The receptacle 2 may have a wall that is flexible or inflexible. For example, as shown in FIGS. 1 to 3, when the receptacle has a flexible wall, the receptacle may have a wide base. Other shapes are possible, and, for example, the receptacle may come in the shape of a tube.

The support 3 may be secured to the receptacle 2 other than by screw fastening. For example, the support may be snap-fastened, or may be made at least in part integrally, i.e., monolithically with the receptacle.

Guiding marks may be made on the nozzle and/or the support to indicate to the user the different angular positions of the nozzle that are possible or recommended.

The lip 42 may be made on the nozzle, if necessary, optionally by modifying said nozzle so as to make it possible for the lip to be made by molding a plastics material. The feed orifice 40 may then be bordered with a circularly cylindrical surface against which the lip would be pressed.

Throughout the description, including in the claims, the term “comprising a” must be understood as meaning “comprising at least one,” unless specified to the contrary.

Although various exemplary details have been described with reference to particular embodiments, it is to be understood that these embodiments are merely illustrative of the principles and applications of the present invention. It is therefore to be understood that numerous modifications may be made to the illustrative embodiments and that other arrangements may be devised based on the foregoing description.

1. A dispenser device comprising:
a support having a feed orifice that can be supplied with fluid; and
a nozzle that has an orifice for passing fluid, said nozzle being mounted so as to pivot on the support between at least:
a closed position at which the nozzle closes the feed orifice of the support;
a first dispensing position at which the feed orifice of the support communicates with the orifice of the nozzle, transition from the closed position to the first dispensing position being effected by turning the nozzle relative to the support;
a second dispensing position, transition from the first dispensing position to the second dispensing position being effected by turning the nozzle further relative to the support, one of the feed orifice of the support and the orifice of the nozzle being provided with a flexible sealing lip that has an edge that is not entirely contained in a single plane and that is arranged in order to seal communication between the feed orifice of the support and the orifice of the nozzle at least in the first and second dispensing positions.

2. A device according to claim 1, wherein the sealing lip is made of a same material as the support.

3. A device according to claim 1, wherein the sealing lip is made monolithically with the support.

4. A device according to claim 1, wherein the edge of the sealing lip extends about a pivot axis of the nozzle relative to the support over an angular sector of at least 45°.

5. A device according to claim 1, wherein the sealing lip is supported by a bead that extends parallel to an axis of the support.

6. A device according to claim 1, wherein the support includes an assembly skirt enabling the support to be secured to a receptacle.

7. A device according claim 6, wherein the skirt has an inside thread.

8. A device according to claim 7, wherein the support has a sealing lip that is configured to be pressed in a leaktight manner against an inside surface of the receptacle.

9. A device according to claim 6, wherein the support has an outside covering skirt that is connected at a top thereof to the assembly skirt.

10. A device according to claim 1, wherein the orifice of the nozzle opens out in a cylindrical surface of the nozzle, said cylindrical surface having a generator line that is parallel to a pivot axis of the nozzle relative to the support.

11. A device according to claim 1, wherein the nozzle is a single piece.

12. A device according to claim 1, wherein the support includes a notch for receiving a pipe of the nozzle when said nozzle is in the closed position.

13. A device according to claim 12, wherein the notch is configured to allow the pipe to be snap-fastened thereto.

14. A device according to claim 1, wherein the sealing lip tapers toward an edge thereof.

15. A device according to claim 1, wherein the sealing lip slopes toward an inside of the orifice.

16. A device according to claim 1, wherein the edge of the sealing lip extends substantially over a circularly cylindrical surface.

17. A device according to claim 1, wherein the support includes housings that receive two opposite studs of the nozzle to hinge the nozzle to the support.

18. A device according to claim 17, wherein the housings are made in such a manner that the studs are snap-fastened thereto.

19. A device according to claim 1, wherein the support has at least a first portion in relief that is arranged to cooperate with a second portion in relief that corresponds to the nozzle, the first and second portions in relief cooperating to generate at least one hard point in the turning of the nozzle at a predetermined orientation of the nozzle relative to the support.

20. A device according to claim 19, wherein the first portion in relief comprises a tab made monolithically with the support, said tab including a tooth arranged to be pressed against the nozzle.

21. A device according to claim 19, wherein the second portion in relief comprises a recess made in the nozzle at a base of a pipe thereof, the first portion in relief becoming engaged in said recess when the nozzle is in a maximally pivoted position.

22. A device according to claim 1, wherein the feed orifice of the support and the orifice of the nozzle extend about a pivot axis of the nozzle relative to the support, respectively over a first angle and a second angle, said second angle being different from the first angle.

23. A device according to claim 1, wherein an entire section of one of the feed orifice of the support and the orifice of the nozzle opens out into the other one of the feed orifice of the support and the orifice of the nozzle when the nozzle is in each of the first and second dispensing positions.

24. A device according to claim 1, wherein one of the feed orifice of the support and the orifice of the nozzle opens out into the other one of the feed orifice of the support and the orifice of the nozzle that is provided with the sealing lip, inside the outline of said lip, at least when the nozzle is in one of the first and second dispensing positions.

25. A device according to claim 1, wherein at least one of the support and the nozzle has an annular bead with an edge that is not contained entirely in a single plane, the sealing lip being connected to the edge of the annular bead.

26. A device according to claim 1, wherein the edge of the sealing lip extends about a pivot axis of the nozzle relative to the support over an angular sector of at least 60°.

27. A device according to claim 1, wherein the edge of the sealing lip extends about a pivot axis of the nozzle relative to the support over an angular sector of about 90°.

28. A device according to claim 5, wherein the axis corresponds to an unmolding direction of the support.

29. A device according to claim 6, wherein the assembly skirt enables the support to be secured to a neck of the receptacle.

30. A device according claim 29, wherein the skirt has an inside thread.

31. A device according to claim 8, wherein the sealing lip is configured to be pressed in a leaktight manner against an inside surface of a neck of the receptacle.

32. A device according to claim 14, wherein the sealing lip has a triangular cross-section.

33. A device according to claim 15, wherein the sealing lip slopes at about 45° relative to a longitudinal axis of a receptacle onto which the support is secured.

34. A device according to claim 22, wherein the angle associated with the orifice provided with the sealing lip is larger than the angle associated with the other orifice.

35. A device according to claim 34, wherein the angle associated with the orifice provided with the sealing lip is at least twice as large as the angle associated with the other orifice.
